(19) United States
(12) Patent Application Publication
(10) Pub. No.: US 2025/0319818 A1
(43) Pub. Date: Oct. 16, 2025

(54) Method for the Harmonized Display of Camera Images in a Motor Vehicle, and Correspondingly Designed Motor Vehicle

(71) Applicant: Bayerische Motoren Werke Aktiengesellschaft, Muenchen (DE)

(72) Inventors: Robert GARTHOFF, Muenchen (DE); Juergen GLATZ, Neufahrn bei Freising (DE); Korbinian WEIKL, Freising (DE)

(21) Appl. No.: 18/881,594

(22) PCT Filed: Jul. 31, 2023
(86) PCT No.: PCT/EP2023/071107

§ 371 Date: Jan. 6, 2025

(30) Foreign Application Priority Data
Aug. 11, 2022 (DE) 10 2022 120 236.4

(51) Int. Cl. B60R 1/27

(52) U.S. Cl. CPC B60R 1/27; B60R 2300/105; B60R 2300/60

(57) ABSTRACT

A method for making vehicle surroundings visible in a motor vehicle for a vehicle occupant, includes a step of recording camera image data, and performing harmonization. In the step of recording, image data of the vehicle surroundings is recorded with multiple different assistance systems of the motor vehicle which each comprise at least one camera. The Harmonization is performed in terms of specified image and/or display properties for homogeneous display of the camera image data with at least one display device of the motor vehicle. Camera image data, required for display with the at least one display device, of the different assistance systems are homogeneously displayed, and correspondingly harmonized.

### BACKGROUND AND SUMMARY

The present disclosure relates to a method for making vehicle surroundings visible in a motor vehicle. The disclosure further relates to a correspondingly designed motor vehicle.

In motor vehicles today, assistance systems are increasingly being employed, and assistance functions offered, which also use cameras for capturing the surroundings. In particular when a camera system with multiple cameras is used here, different representations and image reproductions can exist. This can, for example, make it harder for a user to recognize the representations and to identify objects and the like which are represented from multiple camera views. Not only is this disadvantageous in terms of convenience, but it can also entail a certain safety risk depending on the situation, for example if objects or spatial relationships are not noticed or identified, or are only noticed or identified after a delay, or generally more time and attention are needed for the user to visually register and understand corresponding representations. This time and attention are then, for example, unavailable for the conscious and careful controlling of the vehicle or for observing surrounding areas not covered by the cameras.

A method for color correction for a camera system of a vehicle is described as one approach in DE 10 2020 125 232 A1. The camera system here has multiple cameras for capturing the surroundings which have in each case a field of view for producing a camera image. The color correction of the camera images is effected by a reference value being selected which is located in at least one field of view of the cameras. The color correction of the camera images is then made on the basis of the reference value. It is intended that a method for a surround-view system is thus made available by means of which improved color correction can be obtained.

A method for processing images is described as a further approach in WO 2019/072 451 A1. In this method, surroundings are recorded with two cameras in order to obtain a first image and a second image which show the surroundings from different perspectives. First image areas in the first image and second image areas in the second image are then identified which depict the same predefined areas of the surroundings being studied. A pair, representing the same scene content, consisting of a first image area and a second image area is then recognized.

A method for producing a starting image showing a motor vehicle and an area of the surroundings in a predetermined target view is described as a further approach in DE 10 2017 123 452 A1. This takes place based on at least partially overlapping raw images captured by two cameras on the vehicle, and specified camera-specific types of pixel density which describe an image region-dependent distribution of image data of the respective raw image which contribute to producing the starting image. The raw images are here spatially adaptively filtered based on the respective type of pixel density and mutually corresponding image areas are identified. Spatially adaptive filtering of the image area of the raw image of one camera based on the specific type of pixel density for the other camera also takes place in order to reduce the difference in resolution between the corresponding image areas. Inverse mapping of the filtered raw images onto an image surface corresponding to the target view then takes place in order to produce inverse-mapped filtered raw images. The starting image is then produced by combining the inverse-mapped filtered raw images. It is intended that a solution is thus provided for how corresponding high-quality starting images can be produced in order to display them to a driver of the motor vehicle.

The object of the present disclosure is to make possible the improved representation of camera images in a motor vehicle.

This object is achieved by the subjects of the disclosure. Further possible embodiments of the disclosure are disclosed in the description, and the Figures. Features, advantages, and possible embodiments which are presented within the description for one of the subjects of the independent claims are to be viewed, at least analogously, as features, advantages, and possible embodiments of the respective subject of the other independent claims, as well as any possible combination of the subjects of the independent claims, possibly in conjunction with one of more of the dependent claims.

The method according to the disclosure can be applied in order to make respective vehicle surroundings of a motor vehicle visible in this motor vehicle, in particular in an improved fashion compared with conventional approaches, for a vehicle occupant, in particular a driver of the motor vehicle, i.e. to represent them. In one method step of the method according to the disclosure, in each case camera image data at least of parts or areas of the respective vehicle surroundings of the motor vehicle are recorded by means of multiple different assistance systems of the motor vehicle which each comprise at least one camera. This can, for example, take place simultaneously or in response to a respective requirement, for example when the respective assistance system is activated. The respective camera image data can be individual camera images, a series or sequence of camera images, or a video stream or the like.

The fact that the assistance systems are different can mean, for example, that they are provided, i.e. designed, for different functions. The different assistance systems can thus be separate independent systems. They can, however, be coupled directly or indirectly to one another, for example via an electrical system of the motor vehicle, or can be activated by a central control unit or the like. The different assistance systems can differ not only in terms of their function but also in terms of their hardware and/or software sources. Thus, in particular the cameras of different assistance systems can differ from one another. For example, the cameras can differ from one another in terms of at least one of the following properties and/or components: resolution, focus, camera angle, aperture size, sensitivity, lens, pattern of a Bayer filter. By means of such different resources, i.e. for example cameras and/or data-processing methods and/or the like, correspondingly different camera image data or image outputs of the different assistance systems, or correspondingly different representations of the camera image data of different assistance systems could be created without further measures in the case of representation or output by means of a corresponding display device.

In a further method step of the method according to the disclosure, harmonization, i.e. standardization in terms of specified image and/or display properties for the uniform, homogeneous display or representation of the various camera image data of the different assistance systems, is therefore performed by means of at least one display device of the motor vehicle. This can mean or include corresponding adaptation of the camera image data itself and/or corresponding adaptation of, for example, the activation and/or an output setting of the at least one display device and/or the activation or the operation of one or more of the cameras. This harmonization can be performed, for example, by the different assistance systems, i.e. correspondingly harmonized or networked operation of the assistance systems. Additionally or alternatively, this can be performed by a central harmonization device of the motor vehicle which is coupled to the multiple different assistance systems and to the at least one display device. It can consequently thus be effected and ensured that the camera image data of different assistance systems are or have been correlated with one another and/or with a specified standard or reference value or the like. The specified image and/or display properties can here thus be correspondingly standardized such that the camera image data of different assistance systems are correspondingly standardized and/or can be output,, i.e. represented or displayed, correspondingly standardized, by means of the at least one display device.

In a further method step of the method according to the disclosure, camera image data, required in each case for display or representation by means of the at least one display device, of the different assistance systems are then homogeneously displayed, correspondingly harmonized. This can mean or include, depending on the situation or requirement or application, for example, simultaneous display on one or more display devices or displays or screens, or display of just one selection required in each case, i.e. for example just the camera image data of a specific one of the multiple different assistance systems. In the latter case, the harmonization thus then ensures, in the case of a change to the requirement, i.e. for example when the assistance function used or the assistance system used is switched, that correspondingly other camera image data are displayed without a jump or change in the image and/or display properties occurring. The camera image data of different assistance systems can, for example, here be displayed correspondingly one after the other or alternatingly by means of the same display device or by means of multiple display devices, for example when in each case a specific display device is assigned to an assistance system or an assistance function.

By means of the present disclosure, improved convenience for the vehicle occupant, faster and simpler recognizability of represented camera image data, and hence possibly also improved safety, can be achieved compared with a conventional uncoordinated display of camera image data of different assistance systems. Faster and simpler recognizability can result, for example, from the fact that the time required for the eyes of the respective vehicle occupant or viewer to adjust when there is a change in the viewing of camera image data of different assistance systems can be non-existent or be reduced. Likewise, the vehicle occupant then does not have to manually adapt, for example, display properties of the at least one display device, such as for example its brightness or contrast setting or the like, for consistent recognizability of the camera image data of different assistance systems. In addition, the recognizability of the camera image data of different assistance systems can thus also be independent of or uniform for respective lighting conditions. All these effects can mean that the vehicle occupant can particularly simply and quickly and reliably register and interpret or understand the represented camera image data, also of different assistance systems, and consequently may be distracted or engrossed to a lesser extent and/or for less time. In particular, a vehicle occupant or a respective viewer can thus also recognize objects particularly quickly, in particular also at least potentially safety-related obstacles, in the camera images of different assistance systems, i.e. in each case identify them as the same object. This can also mean enhanced comfort and/or safety.

In one possible embodiment of the present disclosure, the camera image data are recorded by means of cameras of different assistance systems which are located at different positions of the motor vehicle and/or are oriented in different directions. In other words, a camera of a first assistance system can thus be arranged at a first position of the motor vehicle and/or oriented in a first direction, and another camera of a second assistance system can be arranged at a different second position and/or oriented in a different second direction. In such a case, for example owing to angles of incidence of the light and/or shadows and/or the like which differ relative to the different positions and/or orientations, particularly large deviations in terms of the image and/or display properties for respective raw images of the cameras or their representation can result. Accordingly, the embodiment proposed here constitutes a use case in which the present disclosure can be applied particularly effectively and beneficially. Different positions at which the cameras can be arranged can be or include, for example, a windshield area, a front area or front fender area, a tailgate, a rear fender, a side mirror, a body pillar, a sill, and/or the like. Different orientations can in the sense meant here be or include, for example, the longitudinal direction of the vehicle to the front or the rear, the transverse direction of the vehicle to the left or to the right, a direction pointing or standing parallel to a floor of the motor vehicle, a direction rotated thereto about the vehicle longitudinal axis, i.e. in a direction tilted upward or downward in the vertical direction of the vehicle, intermediate directions lying between these directions and/or the like.

In a further possible embodiment of the present disclosure, cameras which differ from one another in terms of at least one hardware and/or software property are used to record the camera image data. In other words, not only are various cameras used in the different assistance systems but also cameras which are actually different. The cameras can differ, for example, in terms of their optics, i.e. for example lenses and/or objectives, in terms of their image sensors, i.e. for example their CCD or CMOS chips or the like, in terms of their image signal processors (ISPs), in terms of the algorithms used, for example, by these ISPs and/or software parameters for image data processing or preparation and/or the like. Cameras which differ in this way can ensure optimal functioning and performance of the different assistance systems because they can place correspondingly different requirements on their cameras. At the same time, a harmonized uniform representation of the camera image data of these different cameras can nevertheless be achieved by the present disclosure. A representation which is optimized in two respects and hence recognizability of the respective vehicle surroundings are thus enabled here.

In a further possible embodiment of the present disclosure, the different assistance systems comprise at least one first assistance system for aiding a continuous driving mode of the motor vehicle and a second assistance system for aiding a parking or maneuvering mode of the motor vehicle. Such assistance systems can place significantly different requirements on their cameras, for example in terms of the orientation and the capturing and recording area, in terms of the maximum distance from the motor vehicle to the objects which are detected in the vehicle surroundings and are to be recognizable in the camera image data, and/or the like. However, the capturing or recording areas of the cameras of such assistance systems can here partially overlap, for example in a front area of the motor vehicle. Consequently, it can be particularly important, for example when transitioning from a continuous driving mode, for example when driving up to a parking space, into parking or maneuvering mode, for example in order to park there, to offer a harmonized homogeneous representation in the camera image data of these different assistance systems. A particularly effective and beneficial use case of the present disclosure thus results here because entering or leaving a parking space or maneuvering is thus, for example, facilitated for the respective driver and, for example, parking lot collisions or touching posts, boundaries, or other obstacles can be prevented particularly reliably.

In one possible development of the present disclosure, the first assistance system is designed for providing AR (augmented reality) functions for navigation. The second assistance system can thus comprise, for example, so-called surround-view cameras, i.e. panoramic-view cameras for capturing the immediate surroundings, i.e. the vicinity around the motor vehicle. By comparison, the first assistance system can comprise, for example, a camera oriented forward in the longitudinal direction of the vehicle and with a narrower field of view extending further away from the motor vehicle, i.e. a capturing or recording area. When the motor vehicle is being used in practice, it can often be necessary to switch between the use of these two assistance systems such that the present disclosure can be applied here particularly beneficially.

In a further possible embodiment of the present disclosure, the image and/or display properties include at least brightness and/or color reproduction and/or color space and/or color temperature and/or contrast. In other words, the camera image data of the different assistance systems are thus harmonized, i.e. standardized, in terms of at least one, in particular many or all, of these properties. The camera image data of an assistance system can then thus be displayed, for example, with the same brightness and/or the same color temperature or the like as the camera image data of another assistance system. These properties can not only generally determine or significantly influence the recognizability of displayed camera image data, but the harmonization of these properties can also in particular facilitate identification or assignment, i.e. tracking of objects which are contained or depicted in the camera image data of multiple assistance systems, for the respective vehicle occupant. The harmonization of the properties proposed here can thus enable or aid particularly simple, fast, and reliable orientation by the vehicle occupant when viewing the camera image data of different assistance systems.

In a further possible embodiment of the present disclosure, in each case at least one predefined variable is included for the harmonization in the individual closed-loop and open-loop control systems of the cameras, which variable is influenced or determined by in each case at least one, many, or all of the other cameras. The variable can here in particular be one which can influence the image and/or display properties, i.e. for example one of the properties mentioned elsewhere or a corresponding parameter or a corresponding camera setting or the like. In other words, the cameras of the different assistance systems are here not subject to closed-loop or open-loop control independently of one another, as is often the case in conventional motor vehicles. Rather, the closed-loop or open-loop control systems of the cameras can here influence one another, in particular mutually. Thus, for example, a camera or camera closed-loop control system which is in each case activated or used first can communicate at least one used variable or a corresponding parameter value to the cameras or camera closed-loop control systems of the other assistance systems which can then likewise use this variable or this parameter value and/or at least one variable derived therefrom. For example, in order to achieve or set a uniform brightness from a communicated exposure time and size of the aperture of a first camera, an exposure time for the second camera can be derived which corresponds but differs because of a different aperture size and/or sensitivity of a second camera. The harmonization of the image and/or display properties over the different assistance systems or their cameras can thus be achieved particularly simply and effectively, for example without any central specification.

It is also possible to react dynamically to changes. For example, the at least one specified variable or a corresponding parameter value can be changed as needed by a camera closed-loop control system, for example because of changed light conditions in the recording area of the corresponding camera or the like. This change can then be communicated automatically to the other assistance systems or their cameras or camera closed-loop control systems and be applied by them. As a result, despite the harmonization, recording and display of the camera image data can furthermore be enabled which is suitable or adapted for very different ambient or recording conditions.

In contrast, individual optimization for each individual camera or for each individual assistance system is often performed in existing vehicles with multiple cameras, wherein in each case specific variables or factors or parameter values which are independent of the other cameras or assistance systems are used. This can result, in particular in the case of different ambient or recording conditions at various points in the vehicle surroundings, in very different representations of the camera image data of different assistance systems. This can be avoided or reduced by the present disclosure.

In a further possible embodiment of the present disclosure, uniform ambient brightness and/or a uniform color temperature, i.e. for example a standardized white balance or the like, is determined for the harmonization based on overlapping areas in which the recording areas, i.e. fields of view of at least two cameras of different assistance systems, overlap or are superposed. This uniform ambient brightness and/or color temperature is then used for the harmonization of the image and/or display properties, in particular for the open-loop or closed-loop exposure control of the individual cameras of the different assistance systems. Similarly, additionally or alternatively, one or more further or different uniform parameters can be determined and used for the harmonization. For the harmonization, a corresponding overall system or a corresponding central harmonization device can here thus use the recording or image areas of the various cameras which overlap in each case. These overlapping areas can be known, i.e. specified, in the case of positioning of the cameras in a fixed location or position relative to one another or relative to the motor vehicle.

Similarly, the overlapping areas can be identified automatically dynamically or be monitored in an estimated fashion if, for example, at least one of the cameras is movably mounted or can change its recording area. In this case, the overlapping areas can be identified or estimated, for example, on the basis of the corresponding closed-loop or open-loop control of the movable or variable camera or cameras, for example by means of a corresponding specified optical model, or based on automatic object recognition and object assignment of objects captured by multiple cameras relative to one another, or the like.

For these overlapping areas, i.e. on the basis of the camera image data of multiple assistance systems depicting them, the uniform, i.e. global ambient brightness and/or the uniform, i.e. global color temperature can then be calculated. The cameras, in particular their closed-loop or open-loop exposure control systems and/or an image processing system by means of the respective ISPs of the individual cameras, can thus be controlled in a closed loop, controlled in an open loop, or adapted such that correspondingly harmonized camera image data result. Particularly effective and robust harmonization can be achieved by the use of the overlapping areas or the camera image data recorded there or the brightness and/or color temperature values identified there and/or other parameters or parameter values because data of multiple assistance systems can then be used which have been recorded or identified under the same local conditions or correspond to the same local conditions.

In a further possible embodiment of the present disclosure, for the harmonization the individual cameras are controlled uniformly in an open or closed loop based on a specified uniform image statistical model and/or uniform reference points in the respective surroundings of the vehicle. The latter can mean, for example, that specified or dynamically determined reference points, for example for a brightness or color temperature setting, are used by all the assistance systems or their cameras or camera closed-loop or open-loop control systems, at least in each case by the assistance systems which can detect a specific reference point by means of their camera or cameras. The specified uniform image statistical model and/or the uniform reference points can be used in particular for the so-called CCLs (camera control loops) and/or a respective dynamic post-processing of the cameras or assistance systems. It can be ensured particularly simply and effectively by the embodiment proposed here of the present disclosure that the image and/or display properties, such as for example the brightness and/or the color reproduction or the like, can be controlled uniformly in a closed or open loop over all the assistance systems.

The disclosure also relates to a motor vehicle which has multiple different assistance systems which in each case comprise at least one camera. The motor vehicle according to the disclosure furthermore has at least one display device. The motor vehicle according to the disclosure is here designed for the harmonized, i.e. standardized display of camera image data recorded by means of the cameras of different assistance systems on or by means of the at least one display device by means of the method according to the disclosure. The motor vehicle according to the disclosure can thus be the motor vehicle mentioned in connection with the method according to the disclosure, or correspond thereto. Accordingly, the motor vehicle according to the disclosure can have some or all of the properties and/or features mentioned in connection with the method according to the disclosure. For the application of the method according to the disclosure in the motor vehicle, the latter can have, for example, a harmonization device which for its part can have, for example, a processing device, such as for example a microprocessor, microchip, or microcontroller or the like, and a computer-readable memory coupled thereto. An operating or computer program which encodes or implements the method steps, measures, or sequences mentioned in connection with the method according to the disclosure can then be saved in this memory. This operating or computer program can then be executable by means of the processing device in order to effect the performance of the corresponding method. The display device can comprise, for example, a screen in an instrument cluster and/or on an instrument panel or center console of the motor vehicle, a head-up display, an infotainment screen, a screen of a navigation system and/or the like. Similarly, a portable electronic device such as, for example, a smartphone or tablet or the like can be used, for example, as the display device or as a part thereof.

Further features of the disclosure can be found in the claims, the Figures, and the description of the Figures. The features and combinations of features which are mentioned above in the description, as well as the features and combinations of features shown in isolation below in the description of the Figures and/or in the Figures can be used not only in the combination stated in each case but also in other combinations or in isolation without going beyond the scope of the disclosure.

### BRIEF DESCRIPTION OF THE DRAWING

FIG. 1 is a schematic illustration of a motor vehicle with multiple camera-based assistance systems and which is designed for a harmonized representation of corresponding camera images.

### DETAILED DESCRIPTION OF THE DRAWING

Vehicles cam today have a large number of different assistance functions which are also camera-based. Especially when directly switching between such camera-based assistance functions which are based on different camera image data, undesired abrupt changes in image and/or display properties, such as brightness, color reproduction, contrast, and/or the like, can occur. This problem can in particular exist or be particularly pronounced when camera image data from cameras are used for different assistance functions which differ from one another, are made by different manufacturers, or at least are not coordinated.

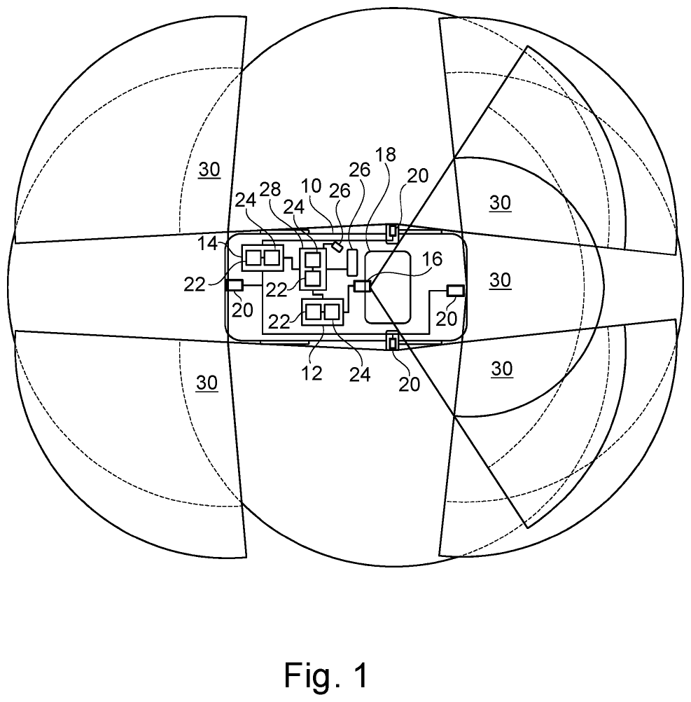

In order to overcome this problem, FIG. 1 shows a schematic exemplary illustration of a motor vehicle 10 which is equipped with multiple camera-based assistance systems. In the present case, these are for example a driving assistance system 12 and a parking assistance system 14. The driving assistance system 12 can be designed, for example, to capture the vehicle surroundings ahead in the driving direction and to display corresponding navigation instructions, for example in a head-up display or the like. The driving assistance system 12 here comprises a front navigation camera 16 for this purpose. This front navigation camera 16 cane be arranged, for example, on or behind a windscreen 18 of the motor vehicle 10.

The parking assistance system 14 can be designed to aid a panoramic view when parking or maneuvering. The parking assistance system 14 can comprise multiple surround-view or panoramic-view cameras 20 arranged in a distributed fashion for this purpose. Such panoramic-view cameras 20 are here arranged, by way of example, in the region of the side mirror, on a front end, and on the rear end of the motor vehicle 10.

The assistance systems 12, 14 can in each case process the camera image data recorded by means of their cameras 16, 20, for example by means of corresponding image signal processing, and control their respective cameras 16, 20 in an open or closed loop, for example depending on the requirement of a driver of the motor vehicle 10, on respective ambient or recording conditions, and/or the like. The assistance systems 12, 14 here have by way of example in each case one processor 22 and a computer-readable memory 24 coupled thereto.

In order to display corresponding camera image data of the different assistance systems 12, 14, the motor vehicle 10 here has at least one display device 26.

The different cameras 16, 20 are located at different positions with different viewing or recording directions and can also use, at least in part, different optics, sensors, ISPs, and/or the like. It is nevertheless intended that a harmonized, uniform image is presented to the driver or a respective vehicle occupant of the motor vehicle 10 via all of the display assistance functions, in particular irrespective of whether the same display device 26 or a variety of display device 26 are used for the display of the camera image data of the different assistance systems 12, 14.

For this purpose, a corresponding harmonization of specified image and/or display properties of the camera image data of the cameras 16, 20 of the different assistance systems 12, 14 is provided. This is performed here, by way of example, by a central harmonization device 28. This harmonization device 28 can take the form of a separate device coupled to the assistance systems 12, 14 and then for its part have, for example, a processor 22 and a memory 24. The harmonization device 28 can also be integrated into one or more of the assistance systems 12, 14 and/or the display device 26 or be realized or implemented as a correspondingly distributed system.

In order to harmonize the camera image data or their image and/or display properties during the display by means of the display device 26, a corresponding overall system, in particular the harmonization device 28, can use image or recording areas of the various cameras 16, 20 which overlap. For illustrative purposes, some recording areas of the various cameras 16, 20 are here indicated schematically in the vehicle surroundings around the motor vehicle 10 and some overlapping areas 30, resulting therefrom, of the various recording areas. Based on these overlapping areas 30 or camera image data recorded there or the prevailing conditions or those relating to the recording or display, the system, i.e. for example the harmonization device 28, can calculate a global ambient brightness and a global color temperature and/or one or more other or further parameters or variables.

Accordingly, open-loop exposure control systems or closed-loop exposure control systems and/or an image signal processing system of the individual cameras 16, 20 or of the assistance systems 12, 14 can then, for example, be controlled in a closed or open loop. This can take place such that images or representations result which are harmonized over all the cameras 16, 20 and assistance systems 12, 14 when displaying the various camera image data by means of the display device 26, i.e. standardized in terms of their image and/or display properties. For this purpose, the assistance systems 12, 14 and/or the harmonization device 28 can use, for example, a specified global image statistical model or common reference points in the respective vehicle surroundings, for example for their camera control loops, i.e. their open-or closed camera control loops, and/or for a respective dynamic post-processing, and/or a corresponding dynamic adaptation of a corresponding ISP parameterization and/or the like.

Important image properties such as, for example, brightness and color reproduction can then thus be controlled uniformly in a closed loop.

As a whole, the examples described show how a system can be realized for the harmonized recording and display of camera images by means of various, in particular different, cameras in a vehicle.

### LIST OF REFERENCE SIGNS

10 motor vehicle
12 driving assistance system
14 parking assistance system
16 front navigation camera
18 windshield
20 panoramic-view camera
22 processor
24 memory
26 display device
28 harmonization device
30 overlapping area

1.-10. (canceled)

11. A method for making vehicle surroundings visible in a motor vehicle for a vehicle occupant, the method comprising:
recording camera image data of the vehicle surroundings with multiple different assistance systems of the motor vehicle which each comprise at least one camera; and
performing harmonization in terms of specified image and/or display properties for homogeneous display of the camera image data with at least one display device of the motor vehicle, wherein
camera image data, required for display with the at least one display device, of the different assistance systems are homogeneously displayed, and correspondingly harmonized.

12. The method according to claim 11, wherein the camera image data are recorded with cameras of different assistance systems which are located at different positions of the motor vehicle and/or are oriented in different directions.

13. The method according to claim 12, wherein the cameras which differ in terms of at least one hardware and/or software property are used to record the camera image data.

14. The method according to claim 11, wherein the different assistance systems comprise a first assistance system configured to aid a continuous driving mode of the motor vehicle and a second assistance system configured to aid a parking or maneuvering mode of the motor vehicle.

15. The method according to claim 14, wherein the first assistance system is configured to supply AR functions associated with navigation, and the second assistance system is configured to provide camera-based representation of the surroundings associated with parking or maneuvering.

16. The method according to claim 11, wherein the specified image and/or display properties include at least one of: brightness, color reproduction, color space, color temperature, and contrast.

17. The method according to claim 11, wherein at least one predefined variable is included in the harmonization in individual closed-loop control systems of the at least one camera, which variable is influenced by another camera.

18. The method according to claim 17, wherein uniform ambient brightness and/or a uniform color temperature is determined for the harmonization based on overlapping areas in which recording areas of the at least one camera of different assistance systems, overlap, and is used for the harmonization of the image and/or display properties, including open-loop exposure control systems of the at least one camera.

19. The method according to claim 18, wherein, in the harmonization, the at least one camera is controlled uniformly in a closed loop based on a specified uniform image statistical model and/or uniform reference points in the vehicle surroundings.

20. A motor vehicle, comprising:
multiple different assistance systems, which comprise at least one camera, and at least one display device, wherein the motor vehicle is configured to provide harmonized display of camera image data recorded with the at least one camera of the multiple different assistance systems on the at least one display device by the method according to claim 11.
